(19) United States
(12) Patent Application Publication
(10) Pub. No.: US 2023/0210324 A1
(43) Pub. Date: Jul. 6, 2023

(54) DUST COLLECTING DEVICE FOR A POWER TOOL

(71) Applicant: Hilti Aktiengesellschaft, Schaan (LI)

(72) Inventor: Uto PLANK, Freising (DE)

(21) Appl. No.: 17/928,023

(22) PCT Filed: Jun. 8, 2021
(86) PCT No.: PCT/EP2021/065249

§ 371 Date: Nov. 28, 2022

(30) Foreign Application Priority Data
Jun. 18, 2020 (EP) 20180797.1

(51) Int. Cl. A47L 7/00; B23Q 11/00; A47L 9/20; A47L 9/10

(52) U.S. Cl. CPC A47L 7/0095; B23Q 11/0071; A47L 9/20; A47L 9/106

(57) ABSTRACT

A dust collecting device for a power tool, the dust collecting device having a lamella filter, a rotatable shaft and a lamella holder. In the collecting container of the dust collecting device, the lamellae of the filter can be set in an axial movement by a rotary movement of the shaft which is mediated by the lamella holder, which is interrupted when a first profile of the shaft and a second profile of the lamella holder are moved with respect to each other and are not in engagement with each other. This enables the lamellae to return to their original position, the return of the lamellae to this original position causing the lamellae to vibrate, which leads to the filter being cleaned. A power tool which can have a proposed dust collecting device, as well as a method for operating a power tool and for cleaning a filter is also provided.

The present invention relates to a dust collecting device for a power tool, the dust collecting device having a lamella filter, a rotatable shaft and a lamella holder. In further aspects, the invention relates to a power tool which can have a dust collecting device, as well as a method for operating a power tool and for cleaning a filter.

### BACKGROUND

Power tools are known in the prior art in which dust that arises when working with the power tool can be extracted by means of an internal dust extraction system. The collected dust can for example be caught in a dust collecting device inside the power tool or collected until the device is emptied. The power tool with dust extraction system can have filters, in particular miniature filters, in order to separate rock and/or dust particles from the air stream. These filters are often filters that have lamellae. In the context of the invention, these are preferably referred to as “lamella filters”. Experience has shown that these filters can easily become clogged with dust or coarse dirt, which can disadvantageously lead to the dust extraction system losing performance or clogging of the extraction channels. In particular, the undesired clogging of the filter can mean that a filling capacity of the dust collecting device cannot be used optimally.

### SUMMARY OF THE INVENTION

Various methods are known in the prior art with which a filter in a dust collecting device of a power tool can be cleaned. Most of these processes are mechanical cleaning processes that have a number of disadvantages. For example, it is proposed in the prior art to sweep the lamellae of the filter in order to clean the filter. However, it can happen that the sweeping device used for this can no longer move when the collecting device is filled with dust. This can disadvantageously impair the functionality of the filter cleaning system. Furthermore, damage to individual components of the dust collecting device can occur if the dust box is partially or completely filled with dust. In the prior art, for example, scrapers, slides or brushes are known as sweeping devices.

Furthermore, the prior art proposes knocking the entire dust collecting device. However, this knocking of the entire dust box often leads to mechanical impairment of the dust collecting device or its components. In the known solutions, knocking the dust collecting device mainly acts on the housing of the collecting container and often does not lead to sufficient cleaning of the filter.

Another cleaning option, which is known from the prior art, is to “blow off” the filter using a reverse air stream. The direction of flow of the suction air stream is in this case reversed by switching off or reducing the negative pressure, so that an air stream flows through the filter for a brief moment, the direction of which is opposite to the usual flow direction in the case of suction. However, it has been shown that the filter cleaning by a reverse air stream does not help or lead to the desired effect in particular when larger lumps of dust or rocks are jammed in the flow channel. This is typically because the reverse air stream is usually not strong enough to loosen or free jammed lumps of dust or rocks from the flow channel. Another disadvantage of cleaning by means of a reverse air stream is that the dust extraction must also be interrupted at the moment when the negative pressure is interrupted. During this cleaning period, the user of the power tool is exposed to the full amount of dust that occurs when working with the power tool.

It is an object of the present invention to provide a device for improved cleaning of the filter in a dust collecting device. In addition, the invention is intended to specify a power tool with a dust collecting device to be provided, as well as a method for operating a power tool or a method for cleaning a filter in a dust collecting device in a power tool. The invention is intended to overcome the disadvantages and deficiencies of the prior art described above and, in particular, to enable efficient and effective cleaning of the filter in a dust collecting device of a power tool. The cleaning should be sufficiently strong to free, for example, lumps of dust or rocks that are jammed in a flow channel of the power tool. It would be welcomed by those skilled in the art if any mechanical stress associated with cleaning were limited to the region of the filter and surrounding components and, in particular, did not act on the housing. In addition, it should be possible with the invention to dispense with the use of inflexible and/or maintenance-prone sweeping devices.

The object is achieved by the subject matter of the independent claims. Advantageous embodiments relating to the subject matter of the independent claim can be found in the dependent subclaims.

The present invention provides a dust collecting device for a power tool, the dust collecting device having a collecting container for receiving the dust. The dust collecting device is characterized in that a filter with lamellae and a rotatable shaft are arranged in the collecting container, the shaft being connected to a lamella holder, the lamella holder, through a rotary movement of the shaft, being movable in an axial direction and cleaning the filter by a return movement. In the context of the invention, it is particularly preferred that the return of the lamellae to their original position causes the lamellae to vibrate, which leads to the filter being cleaned. In this respect, the invention presents a cleaning option for a lamella filter, with the lamella filter being able to filter a dust-laden air stream in a power tool. Due to the compact, mechanical and easy-to-use construction, the invention advantageously provides a particularly robust and low-maintenance dust box for a power tool. Tests have shown that the invention represents a cost-effective technical solution for filter cleaning, which in particular manages without a special sweeping device, knocking the entire dust box or a reverse blast of air. The proposed dust collecting device thus turns away from such solutions which are known from the prior art and breaks new ground in the area of cleaning a filter in a dust collecting device in a power tool.

An essential advantage of the invention is that the filter is cleaned by vibrating the lamellae directly at the point of contamination or at the point of clogging of the filter. This direct action can guarantee a high level of cleaning efficiency. In particular, an effect on the housing of the dust collecting device is avoided in the manner proposed. Another advantage of the invention is that the vibration stroke and the vibration frequency of the filter cleaning can be adjusted. In particular, the acceleration of the lamella holder can be adjusted by the force of the spring, with very high acceleration values also advantageously being able to be achieved. This promotes efficient cleaning of the filter and a cleaning effect of the proposed device.

It is preferred in the context of the invention that there is also a spring in the collecting container, against which the lamella holder can be pressed during its movement in the axial direction. The spring is preferably designed to store energy when it is compressed and to release it again when control profiles allow relaxation. This advantageously makes it possible for the return movement of the lamella holder to be influenced and/or controlled by means of the spring.

In the context of the invention, it is preferred that the shaft has a first profile and the lamella holder has a second profile, the first profile and the second profile being designed to correspond to one another. In this way it is advantageously possible that the first and the second profile can come into engagement with one another. In the context of the invention, it is preferred that the second profile of the lamella holder can come into engagement with the first profile of the shaft, so that the lamella holder can be set into an axial movement by a rotary movement of the shaft. In other words, it is preferred in the context of the invention that the second profile of the lamella holder can come into engagement with the first profile of the shaft, so that the lamella holder is moved in an axial direction by a rotary movement of the shaft. It is preferred in the context of the invention that a lamella holder is arranged axially displaceably on the shaft. The lamella holder can preferably be displaced axially with respect to the shaft. As a result of this axial displaceability of the lamella holder, the conversion of the rotary movement of the shaft into the axial movement of the lamella holder can be made possible. The axial movement of the lamella holder takes place in particular from an original position along an axis which runs essentially parallel to an imaginary central axis which preferably runs centrally through the shaft. The axial movement of the lamella holder is symbolized in FIG. 1 by the double arrow.

It is preferred in the context of the invention that the lamella holder is pressed by the axial movement against a spring, which is preferably also arranged along the imaginary central axis of the shaft in the collecting container of the proposed dust collecting device. The movement of the rotatable shaft is converted into an axial movement of the lamella holder, in particular via the first and the second profile. The lamella holder is preferably mounted in a rotationally fixed manner. It is preferred in the context of the invention that the first and the second profile are designed as a profile and a mating profile with respect to one another. For example, the first and the second profile can be designed as mutually correspondingly designed sawtooth profiles. As such, they can be in engagement with one another. In the event of a movement of one of the two profiles, they can also be moved with respect to each other, wherein jerky movements of the partners involved can occur if one of the profiles arrives at one end of a sawtooth and falls back into a lower position. The sawtooth profiles preferably include inclined planes as contact surfaces. These contact surfaces of the profiles are in contact with one another when the profiles are in engagement with one another. When the profiles move relative to one another, the contact surfaces slide past one another until the end or the highest point of a contact surface is reached. The opposite contact surface of the other profile then loses contact with the ending contact surface and falls back onto the contact surface adjoining in the direction of rotation or its lowest point. The height difference between the highest point of the one contact surface and the lowest point of the adjacent contact surface results in a jerky movement of the lamella holder, which also leads to a return movement of the lamella holder into its starting position. In the context of the invention, it is preferred that the return movement of the lamella holder takes place in a direction opposite to the initial, axial movement of the lamella holder. This return movement can advantageously be supported or controlled by the spring. By means of driving means of the lamella holder, the filter lamellae are also carried along by the jerky return movement of the lamella holder and they can return to their starting position. This is preferably done by means of a vibration or a jerky movement, which causes the lamellae of the filter to be cleaned. In particular, the abrupt return movement of the lamella holder can shake off the dust or filter cake that is situated on or adhering to the lamellae so that the filter can regain its original cleaning power.

In the context of the invention, it is very particularly preferred that the shaft with the first profile is designed to be rotatable, while the lamella holder with the second profile is mounted in a rotationally fixed manner. Examples of the profiles designed to correspond to one another are shown in FIG. 2. In the context of the invention, it is preferred that the profiles face one another so that they can interact with one another. The shaft preferably comprises a cylindrical section which can be inserted into an opening or a cavity in the interior of the lamella holder. In the context of the invention, it is preferred that the lamella holder is arranged between the shaft and the spring. The second profile of the lamella holder is preferably present on the side of the lamella holder facing the shaft. On the side of the lamella holder facing the spring, there can be a circumferential collar, which is preferably designed to transmit a force to the spring. The spring can preferably be designed as a compression or spiral spring.

It is preferred in the context of the invention that the lamella holder has driving means which can engage in the lamellae of the filter or the free spaces between the filter lamellae. In other words, it is preferred in the context of the invention that the driving means are designed to engage in the lamellae of the filter or in free spaces between the lamellae of the filter. The driving means can be designed, for example, as fingers or U-shaped hooks and engage in the spaces between the lamellae. The driving means can preferably be formed from a plastic in a particularly wear-friendly manner, so that the sensitive material of the filter lamellae is not damaged or excessively stressed. By means of these driving means, the lamellae of the filter can be carried along or guided along by the axial movement of the lamella holder. The jerky movement of the lamella holder, which can be generated by the relative movement of the first and second profile, causes the lamellae of the filter to vibrate, which advantageously leads to the dust adhering to the lamellae being shaken off. Thus, the mechanical construction of the proposed dust collecting device advantageously produces a cleaning effect. This cleaning effect is generated in particular by a jerky return movement of the lamella holder when the first profile of the shaft and the second profile of the lamella holder are no longer in engagement with one another when they move relative to one another.

In the context of the invention, it is very particularly preferred that a filter with lamellae and a rotatable shaft with a first profile are arranged in the collecting container of the proposed dust collecting device, the shaft being connected via the first profile to a lamella holder mounted in a rotationally fixed manner, wherein the lamella holder has a second profile which can come into engagement with the first profile of the shaft and can be moved in an axial direction from an original position by rotating the shaft, the lamella holder advantageously cleaning the filter through its return movement.

It is preferred in the context of the invention that the lamella holder and the filter or its lamellae are in form-fitting engagement with one another. By engagement between the lamellae of the filter and the lamella holder, the rotary movement of the shaft can be converted into an axial movement of the filter or the filter lamellae, the lamella holder preferably being connected to the shaft. The axial movement preferably takes place substantially parallel to a central axis of the shaft. The term “substantially parallel” is not an unclear term for a person skilled in the art, because a person skilled in the art knows that the formulation means a movement of the filter lamellae substantially parallel to an axial direction of the shaft, with minor deviations from the exact mathematical parallelism being tolerable.

It is preferred in the context of the invention that the shaft of the proposed dust collecting device is arranged substantially horizontally in the collecting container. It can be set in rotation from the outside using a rotary grip. This rotation represents that rotary movement of the shaft with which the lamellae of the filter can be set in an axial movement with the aid of the lamella holder. In particular, the individual lamellae of the filter can be carried along by the driving means of the lamella holder, which is connected to the shaft, so that the rotational movement of the shaft is converted into an axial movement of the individual lamellae of the filter. The rotary handle can for example be fastened to the shaft with a fastening means such as a screw. In particular, the proposed dust collecting device can have a housing, wherein the rotary handle can be rotatably mounted, for example, in a recess in the housing. The housing can consist of two component halves which can be joined together to form the overall housing of the dust collecting device. The housing or its two component halves advantageously form or enclose a closed hollow or interior space in which the dust that is generated when a power tool is in operation can be collected. The proposed dust collecting device can in particular be designed as a component of a power tool. In the context of the invention, the proposed dust collecting device can preferably be referred to as a “dust box” or as a “dust removal module”.

If dust arises during operation of the power tool, this dust can be extracted by means of a dust extraction system, which can also be part of the power tool. For this purpose, the dust extraction system can generate a negative pressure with which an air stream can be generated with which the dust can be removed from a work area of the power tool. The dust-laden air stream is preferably guided in the direction of the dust collecting device. The dust collecting device preferably has an opening through which the air stream can enter the dust collecting device. It is preferred in the context of the invention that the filter is present in this opening or inlet region of the dust collecting device. It can happen that the filter becomes clogged if the power tool is in operation for a long time or if the air stream is very dust-laden. In this case, for example, a solid filter cake forms, which can lead to the extraction system losing suction power and clogging the suction channels. In addition, the filter becoming clogged may possibly result in the capacity of the dust collecting device or its collecting container not being used optimally.

Advantageously, the invention can provide a possibility for quick, inexpensive, low-maintenance and effective cleaning of the filter. It is preferred in the context of the invention that the cleaning process is started by actuating a rotary handle of the dust collecting device. By actuating the rotary handle, the shaft is preferably set in rotation within the collecting container of the dust collecting device. It is preferred in the context of the invention that the lamella holder has driving means which can come into engagement with the lamellae of the filter or with the free spaces between the filter lamellae. It is preferred in the context of the invention that the rotary movement of the shaft can be converted into an axial movement of the lamellae of the filter.

Before the start of the rotary movement, the lamellae are in an original or starting position with respect to the shaft or the lamella holder or its driving means. As a result of the axial movement, the filter lamellae are moved out of their starting position, in particular along an axial direction of the shaft. For example, due to their axial movement in the lateral direction, the lamellae can move by a length d to the right or left. The length d then preferably represents the distance between a lamella and its starting position. It is preferred in the context of the invention that each lamella has its own original position. For example, the lamella holder can have three to ten driving means. It has been shown that lamella holders with five driving means are particularly well suited for the purposes of the invention. It is preferred in the context of the invention that the number of driving means of the lamella holder correlates with a number of lamellae of the filter. In the context of the invention, this correlation can mean that the number of driving means of the lamella holder is the same as the number of lamellae of the filter. In the context of the invention, however, it is very particularly preferred that the number of lamellae of the filter is 1 greater than the number of driving means of the lamella holder. This advantageously makes it possible for each driving means to engage in a space between the filter lamellae and to carry the lamella along with it during the rotary movement of the shaft or during the axial movement of the lamella holder. This preferably generates the axial movement of the filter lamellae, which causes the filter to spring back and be cleaned. In other words, it can be preferred in the context of the invention that the lamella holder has a number of n driving means and the filter has a number of n+1 lamellae.

The springing back or snapback of the lamellae of the filter preferably causes them to be vibrated, whereby the dust or filter cake can be loosened and/or shaken off the lamellae. In particular, the vibration enables effective and efficient cleaning of the filter lamellae or the filter. The often jerky movement of the lamella holder advantageously leads to a vibration of the lamellae, through which the dust or the filter cake can loosen in the clogged or blocked-up filter. In particular, a cleaning effect is brought about by the advantageous interaction of the rotatable shaft, the lamella holder and the filter.

It is preferred in the context of the invention that the collecting container has a rotary handle with which the shaft can be set in rotation. In other words, it is preferred in the context of the invention that the rotary handle is designed to set the shaft in rotation. This rotary movement can in particular take place by a preferably manual actuation by the user of the power tool. In an alternative embodiment of the invention, it can also be preferred that the shaft is driven by drive means. For this purpose, an electric motor can be provided that can be activated or deactivated with a switch. In the alternative embodiment of the invention, this switch can be arranged in the region on the housing of the dust collecting device in which the rotary handle is provided in the “manual embodiment” of the invention. For ergonomic reasons, however, the switch can also be arranged at various other locations.

The invention is preferably situated within the technical field of dust removal from a work area of a power tool. The work area of the power tool preferably represents that area in which the work to be carried out with the power tool is performed. This is mostly done with the help of a tool. If the power tool is, for example, a hammer drill, the tool can be formed, for example, by a drilling or chiseling tool. The area in which the drilling or chiseling tool, as a tool of the power tool, comes into contact with a substrate to be machined is preferably referred to as the “working area of the power tool” in the context of the invention. In the context of the invention, it is preferred that the dust that is preferably to be collected by means of the present invention is generated in this work area. For this purpose, the power tool can include a dust extraction system. It is preferred in the context of the invention that the dust extraction system is a device that is designed to generate an air stream or a negative pressure and to suck off the dust that can arise in the working area of the power tool during its operation, with the air stream.

The invention relates in a second aspect to a power tool with a dust extraction system for removing particles from a work area of the power tool. In particular, it is provided that the power tool has a proposed dust collecting device. The power tool is characterized in that a filter with lamellae and a rotatable shaft are arranged in the collecting container, the shaft being connected to a lamella holder, the lamella holder, through a rotary movement of the shaft, being movable in an axial direction and the lamella holder cleaning the filter by a return movement. It represents a significant advantage of the proposed dust collecting device that this vibration leads to the filter being cleaned.

It is preferred in the context of the invention that the power tool comprises a dust extraction system, the dust extraction system being designed to generate an air stream with which dust is removed. The dust extraction system is used in particular to allow the dust to be extracted from the work area of the power tool. For this purpose, the dust extraction system of the power tool is preferably designed to generate a negative pressure, which in turn generates an air stream. With this air stream, the dust can be removed from the working area of the power tool and guided in the direction of the dust collecting device. A flow channel for the air stream is preferably provided in the power tool, through which channel the air stream is guided from the work area to the dust collecting device. The dust that arises during operation of the power tool can preferably be collected in a collecting container of the dust collecting device. When entering the dust collecting device, it is preferred in the context of the invention that the air stream is filtered. For this purpose, a filter can be provided in the inlet region of the dust collecting device or the collecting container of the dust collecting device. The filter has lamellae, with a key merit of the lamellae being to enlarge the surface of the filter and thus to increase the filter performance of the filter. This allows the air stream to be filtered particularly effectively and freed of relatively coarse dust particles.

It is very particularly preferred in the context of the invention that the filter is designed to filter out dust and/or dust particles from an air stream leading into the collecting container of the proposed dust collecting device. In other words, it is preferred in the context of the invention that the filter is present at the inlet region of the collecting container, the air stream in this inlet region preferably opening into the collecting container. The inlet region of the collecting container preferably represents that region of the collecting container in which the air stream enters the collecting container and is still fully laden with dust, particles and/or pieces of rock. By filtering these relatively coarse dust particles out of the air stream, the functionality of the proposed dust collecting device can be improved and its service life can be extended.

In a further aspect, the invention relates to a method for operating a power tool and for cleaning a filter. The method is characterized by the following method steps:
a) operation of the power tool, wherein dust that arises during operation of the power tool is removed by means of an air stream,
b) filtering of the dust from the air stream with a filter,
c) initiation of the cleaning of the filter by actuating a rotary handle on a dust collecting device, wherein a shaft within the dust collecting device is set in rotation by actuating the rotary handle,
d) conversion of the rotary movement of the shaft into an axial movement of a lamella holder, the lamellae of the filter leaving an original position due to the axial movement of the lamella holder,
e) return of the lamellae of the filter to their original position by moving the lamella holder back,
f) cleaning of the filter by returning the lamellae to their original position.

In the context of the proposed filter cleaning method, it is preferred that the dust can be sucked out of a work area of the power tool by a dust extraction system of the power tool. This is achieved in particular in that an air stream is generated by the dust extraction system, with which the dust can be removed from the work area of the power tool. The dust is preferably collected in the collecting container of the dust collecting device, the air stream passing through a filter when it enters the collecting container. It can happen that the filter becomes clogged if the power tool is in operation for a long time or if the air stream is very dust-laden. For example, a so-called filter cake can form in the filter. In this situation, the invention advantageously makes it possible to initiate cleaning of the filter, the filter cleaning being started in particular by actuating a rotary handle on an outer side of the dust collecting device. For example, the rotary handle can be rotatably mounted in a recess in the housing.

In the context of the invention, it is preferred that the shaft is set in rotation within the dust collecting device by actuating the rotary handle. The shaft is in connection with a lamella holder, the connection being formed in particular by a first profile of the shaft and a second profile of the lamella holder. The profiles preferably represent surfaces designed to correspond to one another, which are opposite one another and can come into engagement with one another. The lamella holder is preferably mounted in a rotationally fixed manner. In this way, the rotary movement of the shaft can be converted into an axial movement of the lamella holder. The lamella holder can have driving means, which are preferably designed to also cause the lamellae of the filter to move axially in the direction of movement of the lamella holder. Leaving their original position by the lamellae of the filter is preferably also referred to in the context of the invention as the lamella holder driving the filter lamellae along. For this purpose, the lamella holder can have driving means, wherein the driving means can engage in the lamellae of the filter or the free spaces between the filter lamellae. In other words, it is preferred in the context of the invention that a rotary movement of the shaft is converted into an axial movement of the lamellae of the filter, the lamellae of the filter leaving their original position as a result of the axial movement. The invention preferably has a first profile on the shaft and a second profile on the lamella holder, which allow the lamellae of the filter to return to their original position when the profiles disengage from one another due to a relative movement. The filter can advantageously be cleaned by vibrating the lamellae of the filter, the vibration being caused by the return of the lamellae to their original position or a return of the lamella holder to its original position.

The definitions, technical effects and advantages that have been described for the proposed dust collection device apply analogously to the operating and cleaning process as well as to the power tool.

It is preferred in the context of the invention that the lamella holder is pressed against a spring by the axial movement. It represents a further advantage of the invention that the return movement of the lamella holder can be influenced by means of the spring. In particular, the vibration stroke, the vibration frequency and the acceleration of the lamella holder can be controlled in this way.

In the context of the invention, it is preferred that the rotational movement of the shaft is converted into the axial movement of the lamella holder via a first profile of the shaft and a second profile of the lamella holder. The filter is preferably cleaned by vibrating the filter lamellae when a first profile of the shaft and a second profile of the lamella holder are moved with respect to one another and are not in engagement with one another. In the context of the invention, it is preferred that the lamellae of the filter are driven along from their starting or original position by driving means of the lamella holder. These can be designed like fingers or as U-shaped hooks or eyes.

In one embodiment of the invention, the shaft can be set in rotation via a rotary handle attached to the outside of the housing of the dust collecting device. A lamella holder is arranged axially displaceably on the shaft. The lamella holder preferably has a sawtooth profile on the side facing the shaft, which in the context of the present invention is preferably referred to as the second profile. On the side facing the lamella holder, the shaft has a mating profile which, in the context of the present invention, is preferably referred to as the first profile. During rotation, the lamella holder, which is preferably mounted in a rotationally fixed manner, is displaced axially against the spring via the sawtooth profile of the lamella holder and the mating profile of the shaft. With this axial displacement of the lamella holder, the lamellae of the filter can be driven along. As soon as the sawtooth profile of the lamella holder and the mating profile of the shaft release the lamella holder, the lamella holder can suddenly move back into its starting position due to the force of the spring and thereby drive the filter lamellae along with it. The abrupt backward movement of the lamella holder shakes off the dust adhering to the lamellae.

### BRIEF DESCRIPTION OF THE DRAWINGS

Further advantages of the invention will become apparent from the following description of the figures. The figure shows an exemplary embodiment of the present invention. The figure, the description and the claims contain numerous features in combination. A person skilled in the art will expediently also consider the features individually and combine them to form useful further combinations.

In the figures, identical and similar components are denoted by the same reference signs. In the drawing:

FIG. 1 shows a view of a preferred embodiment of the proposed dust collecting device (exploded drawing),

FIG. 2 shows a view of a preferred embodiment of the shaft and the lamella holder, as well as their profiles,

FIG. 3 shows a view of a preferred embodiment of the lamella holder, the spring and the filter lamellae.

### DETAILED DESCRIPTION

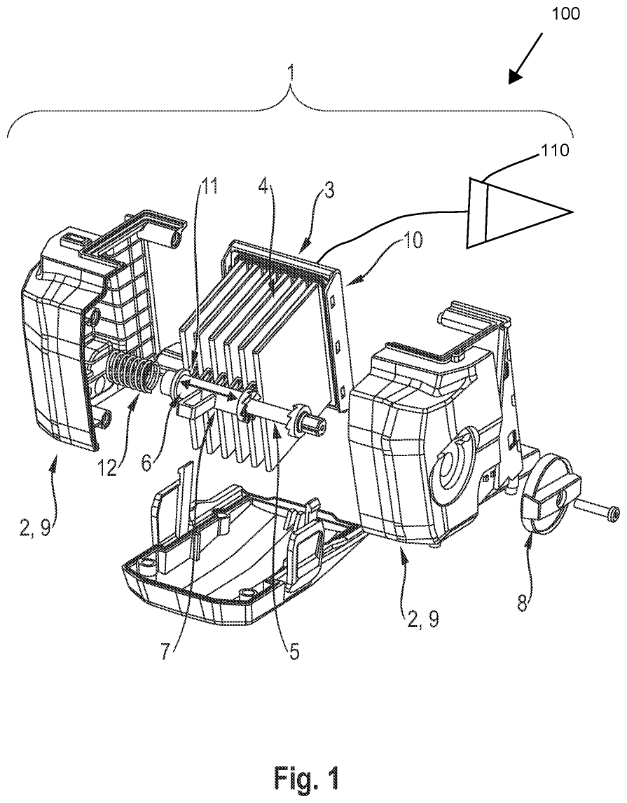

FIG. 1 shows the view of a preferred embodiment of the proposed dust collecting device (1). In particular, FIG. 1 shows an exploded drawing of the dust collecting device (1). From top left to bottom right, FIG. 1 shows a first half of the housing (9) of the dust collecting device (1) or the collecting container (2), the spring (12), the filter (3) and its lamellae (4), as well as the shaft (5) and the lamella holder (7) with the driving means (11), a second half of the housing (9) of the dust collecting device (1) or the collecting container (2), and the rotary handle (8).

It is preferred in the context of the invention that the two component halves of the housing (9) enclose a volume of space, wherein dust can be captured and collected in this closed volume of space. In this respect, the two component halves of the housing (9) preferably form the collecting container (2) of the dust collecting device (1). The lower region of the collecting container (2) can be formed by a base or a shell. A front side of the dust collecting device (1), in which a filter (3) can be arranged, can extend starting from this underside of the collecting container (2). In the context of the invention, it is preferred that the front side of the dust collecting device (1) forms the inlet region (10) of the dust collecting device (1) into which the dust-laden air stream opens. In particular, the filter (3) can be arranged in a filter receptacle. The filter (3) is preferably a lamella filter, that is to say preferably a filter (3) which has lamellae (4). In the exemplary embodiment of the invention shown in FIG. 1, the filter (3) has, for example, six lamellae (4), with five spaces between the lamellae (4). In the context of the invention, it is preferred that the lamella holder (7), which is connected to the shaft (5), has driving means (11), the lamella holder (7) shown by way of example in FIG. 1 comprising five driving means (11). As a result, each driving means (11) can engage in a space between the lamellae and drive or carry the filter lamellae (4) along with it when the lamella holder (7) moves.

The two component halves of the housing (9) can have openings for receiving this shaft (5). In particular, the shaft (5) can be rotatably mounted within the dust collecting device (1), with the shaft (5) being able to be set in rotation in particular by means of a rotary handle (8). The rotary handle (8) can, for example, be accessible from the outside and manually actuated by a user of the power tool (shown solely schematically as 100 with dust extraction device 110). For this purpose, the user can in particular turn the rotary handle (8). The rotary handle (8) is preferably rotatably mounted within the housing (9) of the dust collecting device (1). For this purpose, the housing (9) or one of its component halves can have a recess for receiving the rotary handle (8). The rotary handle (8) is advantageously easily accessible from outside the dust collecting device (1).

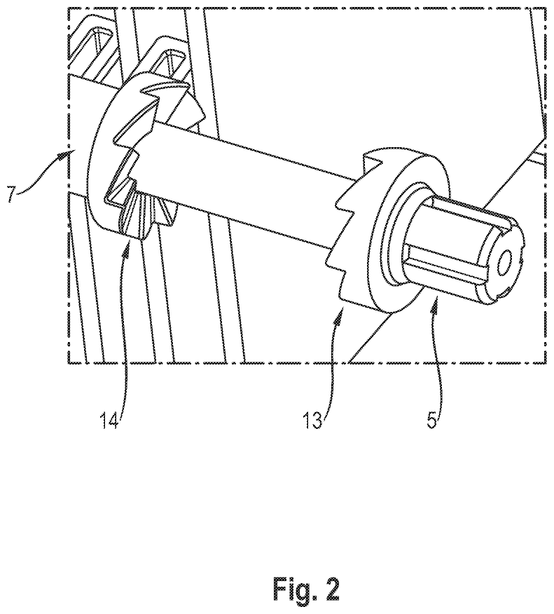

By actuating the rotary handle (8), the shaft (5) is set in a rotary movement. The shaft (5) and the lamella holder (7) preferably have opposing profiles (13, 14) which can come into engagement with one another (see, e.g., FIG. 2). The profile (13) of the shaft (5) is preferably referred to as the first profile, while the profile (14) of the lamella holder (7) can be referred to as the second profile. The profiles (13, 14) are preferably designed to correspond to one another, for example as sawtooth profiles. It is preferred in the context of the invention that the second profile (14) of the lamella holder (7) can come into engagement with the first profile of the shaft (5), so that the lamella holder (7) can be set into an axial movement (6) by a rotary movement of the shaft (5).

The lamella holder (7) can have driving means (11) which are designed to engage in the spaces between the lamellae (4) of the filter (3) of the proposed dust collecting device (1). If the driving means (11) are in engagement with the lamellae (4) of the filter (3) or with the free spaces between the lamellae (4) of the filter (3), the lamella holder (7) drives along the lamellae (4) when the shaft (5) rotates. Before the lamellae (4) are driven along by the lamella holder (7), the filter lamellae (4) are preferably in a starting or original position. The driving of the filter lamellae (4) generates an axial movement (6) of the lamellae (4) of the filter (3), which is shown in FIG. 1 as a double arrow. The double arrow indicates that the lamellae (4) of the filter (3) can move, for example, in the direction of the first component half of the housing (9) of the dust collecting device (1) when they are driven along by the lamella holder (7). The lamella holder (7) is preferably designed to be axially displaceable with respect to the shaft (5). The axial movement (6) of the filter lamellae (4) preferably takes place substantially parallel to a central axis, which runs through the shaft (5) as an imaginary axis. In the context of the invention, it is preferred that the driving of the filter lamellae (4) ends when the first profile (13) of the shaft (5) and the second profile (14) of the lamella holder (7) disengage from each other, that is to say no longer are in engagement with each other. Due to the lack of contact between the profiles (13, 14), the lamella holder (7) moves suddenly and the filter lamellae (4) are released. In the context of the invention, this preferably means that the lamellae (4) of the filter (3) can spring back into their starting position. This return movement of the filter lamellae (4) can take place, for example, in the direction of the second component half of the housing (9) of the dust collecting device (1), with this snapback of the lamellae (4) of the filter (3) being able to cause that vibration that advantageously leads to dust and filter cake being released from the lamellae (4) and the filter (3) being cleaned. In other words, when the filter lamellae (4) spring back into their starting position, the filter lamellae (4) may in particular vibrate, releasing dust and filter cake from the filter (3). The released dust or filter cake can fall into the collecting container (2) of the dust collecting device (1) and be disposed of when the collecting container (2) is next emptied.

FIG. 2 shows the view of a preferred embodiment of the proposed dust collecting device (1), in particular the shaft and the lamella holder, and their profiles. In the exemplary embodiment of the invention that is shown in FIG. 2, the two profiles (13, 14) are designed as mutually correspondingly designed sawtooth profiles. The profiles (13, 14) have contact surfaces which are preferably formed by inclined planes. A person skilled in the art has knowledge of the term “inclined plane”. FIG. 2 shows how the first profile (13) of the shaft (5) and the second profile (14) of the lamella holder (7) can be opposite one another. In the event of contact between the profiles (13, 14), in particular a highest point of a contact surface of one profile (13 or 14) can be in contact with a lowest point of a contact surface of the other profile (14 or 13). By moving the profiles (13, 14) relative to one another, the contact surfaces are moved along each other until a highest point of one of the inclined planes is reached and the highest point of the opposite contact surface of the other profile falls down onto the next contact surface or its lowest point. This dropping down leads to the jerky movement of the lamella holder (7), which leads to the vibration of the filter lamellae (4) and to the cleaning of the filter.

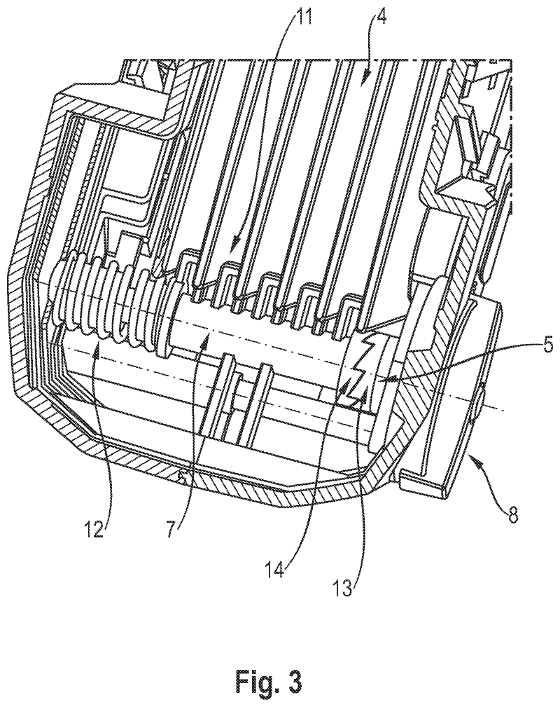

FIG. 3 shows a view of a preferred embodiment of the lamella holder (7) with driving means (11). The lamella holder (7) depicted in FIG. 3 has, in particular, five driving means (11) which can come into engagement or interact with the spaces between the filter lamellae (4) in order to convert a rotary movement of the shaft (5) into an axial movement (6) of the lamellae (4). Furthermore, the spring (12) is shown in FIG. 3, against which the lamella holder (7) can be pressed as a result of its axial movement (6).

### LIST OF REFERENCE SIGNS

1 Dust collecting device
2 Collecting container
3 Filter
4 Lamellae
5 Shaft
6 Axial movement
7 Lamella holder
8 Rotary handle
9 Housing
10 Inlet region
11 Driving means
12 Spring
13 First profile of the shaft
14 Second profile of the lamella holder
100 Power tool
110 Dust Extractor

What is claimed is:

1-15. (canceled)

16. A dust collecting device for a power tool, the dust collecting device comprising:
a collecting container for receiving dust;
a filter with lamellae and a rotatable shaft arranged in the collecting container, the shaft being connected to a lamella holder, the lamella holder, through a rotary movement of the shaft, being movable in an axial direction, and the lamella holder cleaning the filter by a return movement.

17. The dust collecting device as recited in claim 16 further comprising, in the collecting container, a spring against which the lamella holder is pressable during movement in the axial direction.

18. The dust collecting device as recited in claim 16 wherein the shaft has a first profile and the lamella holder has a second profile, the first profile and the second profile designed to correspond to one another.

19. The dust collecting device as recited in claim 18 wherein the second profile is engageable with the first profile of the shaft, so that the lamella holder is movable in the axial direction by a rotary movement of the shaft.

20. The dust collecting device as recited in claim 16 wherein the lamella holder is mounted in a rotationally fixed manner.

21. The dust collecting device as recited in claim 16 wherein the lamella holder has driving means, the driving means being designed to engage in the lamellae of the filter or in free spaces between the lamellae of the filter.

22. The dust collecting device as recited in claim 16 wherein the collecting container has a rotary handle, the rotary handle being designed to set the shaft in rotation.

23. The dust collecting device as recited in claim 22 wherein the rotary handle is present in a housing of the collecting container.

24. The dust collecting device as recited in claim 16 wherein the filter is arranged in an inlet region of the collecting container of the dust collecting device.

25. A power tool comprising the dust collecting device as recited in claim 16.

26. A method for operating a power tool and for cleaning a filter, the method comprising:
a) operating the power tool, dust arising during operation of the power tool being removed by an air stream,
b) filtering the dust from the air stream with a filter,
c) initiating cleaning of the filter by actuating a rotary handle on a dust collecting device, wherein a shaft within the dust collecting device is set in rotation by actuating the rotary handle,
d) converting rotary movement of the shaft into an axial movement of a lamella holder, the lamellae of the filter leaving an original position due to the axial movement of the lamella holder,
e) returning the lamellae of the filter to the original position by moving the lamella holder back,
f) cleaning the filter by returning the lamellae to the original position.

27. The method as recited in claim 26 wherein the lamella holder is pressed against a spring by the axial movement.

28. The method as recited in claim 26 wherein the converting of the rotary movement of the shaft into the axial movement of the lamella holder takes place via a first profile of the shaft and a second profile of the lamella holder.

29. The method as recited in claim 26 wherein the filter is cleaned by vibrating the lamellae of the filter when a first profile of the shaft and a second profile of the lamella holder are moved against each other and are not in engagement with each other.

30. The method as recited in claim 26 wherein the lamellae of the filter are driven along by driving means of the lamella holder.
